(19) United States
(12) Patent Application Publication
(10) Pub. No.: US 2019/0124055 A1
(43) Pub. Date: Apr. 25, 2019

(54) ETHERNET SECURITY SYSTEM AND METHOD

(71) Applicant: Ultra Electronics, 3eTI, Rockville, MD (US)

(72) Inventors: Qiang Guo, Vienna, VA (US); Chaoxing Lin, Clarksburg, MD (US); Rich Brazda, Lincoln, NE (US)

(21) Appl. No.: 16/169,667

(22) Filed: Oct. 24, 2018

Related U.S. Application Data
(60) Provisional application No. 62/576,324, filed on Oct. 24, 2017.

(51) Int. Cl. H04L 29/06; H04W 12/10; H04W 4/80

(52) U.S. Cl. CPC H04L 63/0485; H04L 63/20; H04L 12/4641; H04W 4/80; H04W 12/10

(57) ABSTRACT

A network security apparatus includes a memory, a first network interface, a second network interface, and a processor. The processor is operatively coupled to the memory, the first network interface and the second network interface. The processor is configured to bridge encrypt network traffic at the first network interface to a different network encryption at the second network interface.

### CROSS-REFERENCE TO RELATED APPLICATION

This application claims priority to U.S. Provisional Patent Application No. 62/576,324, filed Oct. 24, 2017, the disclosure of which is incorporated herein by reference in its entirety.

### BACKGROUND

Legacy local area network (LAN) devices broadcast in unencrypted or clear text and are vulnerable to cyber-attacks such as data reply and address resolution protocol (ARP) spoofing. There are no strong security measures deployed on the current state of the IEEE 802.3 Ethernet based LAN network. OSI layer 2 traffic such as address resolution protocol (ARP), link layer discovery protocol (LLDP), link aggregation control protocol (LACP) and IEEE 802.3 Ethernet data packets are generally in clear text without privacy or integrity protection. This makes it easy for hackers to perform network reconnaissance through data capturing and analysis.

While more secure LAN devices such as IEEE 802.1ae and other vendor proprietary mechanisms have been developed to protect Ethernet MAC layer data privacy and integrity, those systems require the LAN host to implement technologies to take advantage of the protection. Legacy LAN host devices are still vulnerable on the LAN environment. It may not be possible to change the legacy LAN host device itself in certain hardware. For example, medical imaging equipment and other equipment that requires certification of hardware (military, industrial systems, etc) may not be easily modified.

### BRIEF SUMMARY

In an example, methods and systems for MAC layer securities for IEEE 802.3 devices on a Local Area Network (LAN) are described.

In an embodiment, a system includes an encrypted interface and one or more clear text interfaces. The system provides encryption services on one or more of its Ethernet interfaces. The system provides a data bridging service from an encrypted interface to one or more clear text interfaces.

In an embodiment, a method provides LAN data privacy and integrity protection to legacy host devices that may not have built-in encryption capabilities.

In an embodiment, a network security apparatus includes a memory, a first network interface, a second network interface, and a processor. The processor is operatively coupled to the memory, the first network interface and the second network interface. The processor is configured to receive a first address resolution message at the first network interface, transmit a second address resolution message at the second network interface, populate the address lookup table based on a response to the second address resolution message received at the second network interface, and bridge encrypted network traffic at the first network interface to a different network encryption at the second network interface.

In an embodiment, a network security apparatus includes a memory, a first network interface, a second network interface, and a processor. The processor is operatively coupled to the memory, the first network interface and the second network interface. The processor is configured to bridge encrypted network traffic at the first network interface to a different network encryption at the second network interface, and control a transmit size of messages received at the second network interface.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a block diagram of an exemplary security system and coupled devices.

FIG. 2 is a block diagram of an exemplary encryption data packet frame.

FIG. 3 is a flow chart illustrating address resolution.

FIG. 4 is a flow chart illustrating processing a message received at an encrypted network interface.

FIG. 5 is a flow chart illustrating processing a message received at a network interface.

### DETAILED DESCRIPTION

Various features and advantageous details are explained more fully with reference to the nonlimiting embodiments that are illustrated in the accompanying drawings and detailed in the following description. It should be understood, however, that the detailed description and the specific examples are given by way of illustration only, and not by way of limitation. Various substitutions, modifications, additions, and/or rearrangements within the spirit and/or scope of the disclosure will become apparent to those skilled in the art.

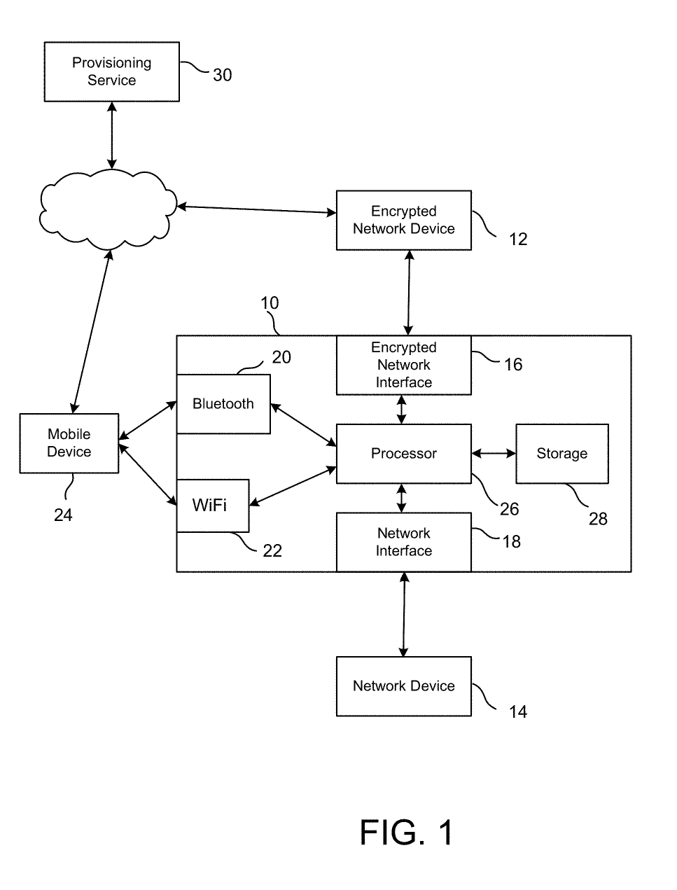

Referring to FIG. 1, an exemplary medium access control (MAC) security system 10 includes an encrypted network interface 16, a network interface 18, a Bluetooth (or other short range radio such as NFC) interface 20 and a WiFi interface 22. It will be appreciated that different embodiments will include various of the interfaces. For example, some embodiments may include only the encrypted network interface 16 and network interface 18. Other embodiments may include the encrypted network interface 16, the network interface 18, and the Bluetooth interface 20, and so forth. In a preferred embodiment, the encrypted network interface 16 includes an encrypted Ethernet port and the network interface 18 includes an unencrypted network interface. It will be appreciated that the term unencrypted does not exclude all types of encryption but rather simply denotes that the unencrypted Ethernet port 18 is less secure (or uses different security or network encryption) than the Ethernet port 16.

The system 10 includes at least one processor 26 and storage 28 that are configured to perform various tasks according to some embodiments, such as one or more methods disclosed herein. To perform these various tasks, the processor 26 is respectively coupled to the interfaces 16, 18, 20 and 22 to communicate with devices 12, 14 and 24.

The processor can include a microprocessor, microcontroller, processor module, programmable integrated circuit, programmable gate array, or other control device. The storage 28 may include one or more computer-readable or machine-readable storage media, such as RAM, ROM, SSD or other types of storage.

It will be appreciated that the system 10 is exemplary as illustrated and the system 10 and that system 10 may have more or fewer components than shown. It will also be understood that the processes described herein may be implemented in hardware, software, or a combination thereof.

The system 10 provides encryption service over the encrypted network interface 16 to provide a secure link between the encrypted network device 12 and the encrypted network interface 16. The number of Ethernet interfaces 16 is exemplary and two or more may also be included. Each interface 16 may be secured used different keys. The exemplary system 10 may perform IEEE 802.3 data packet encryption/decryption via several methods. The methods may be used individually or in combination alone or with other methods.

In an exemplary method, the MAC security system 10 includes an Ethernet MAC security system that acts as an IEEE 802.1ae host on its encrypted (Ethernet) network interface 16 and sets up a Media Access Control Security (MACsec) session with an IEEE 802.1ae enabled network switch 12 as the encrypted network device.

In another method, the encrypted network device 12 includes a peer system 12 and a Virtual LAN (VLAN) is set up between the system 10 and the peer system 12 using static encryption keys. The physical connection to the peer system 12 may be over multiple Ethernet hubs, repeaters and switches, and may traverse public IP based networks. Preferably, the peer system 12 and the system 10 reside on the same VLAN. The system 10 may support both methods for Ethernet frames encryption over the interface 16. The choice of the method at runtime may be determined through configuration and/or runtime discovery by the system.

The exemplary MAC security system 10 is coupled to one or more network devices 14 over its network interface 18. The network devices 14 may include, but are not limited to, computers, printers, network storage devices, networked electronic devices, networked medical devices, network industrial control devices and other electronic devices. In some examples, the network devices 14 have no built-in Ethernet encryption capability.

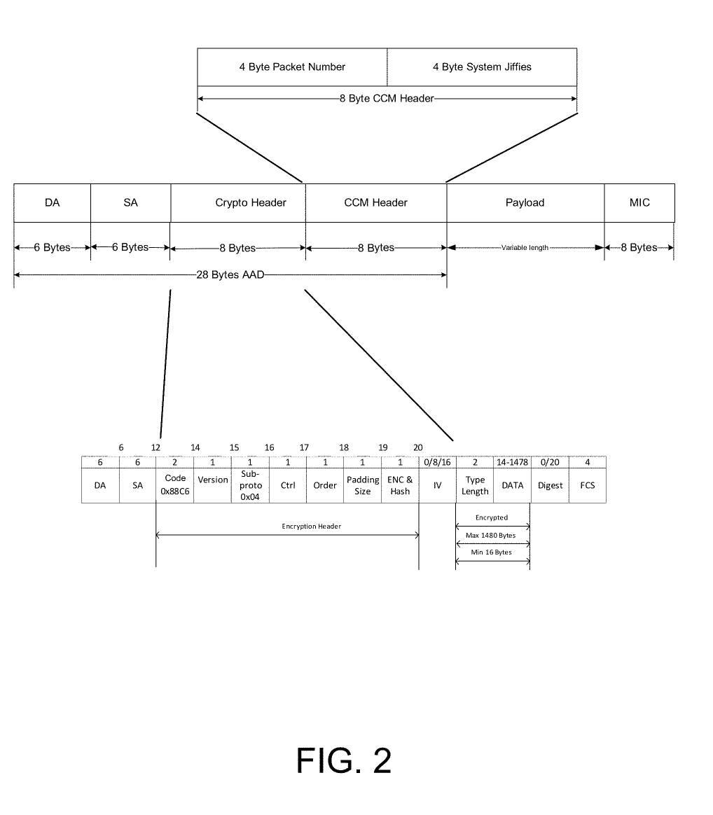

The system 10 may not be assigned its own IP address. In the example where one network device 14 is connected to the network interface 18, the system 10 may behave like a “bump-in-the-wire” encryptor. FIG. 2 illustrates an example of a data packet. The data packet includes a destination address (DA), a source address (SA), a crypto header, a CCM header, payload and a message integrity check (MIC). In the example of a VLAN encryption data packet, the DA, SA, crypto header and CCM provide additional authentication data (AAD).

For incoming data on the interface 18, the system 10 receives the packet, the payload is encrypted, the source MAC address that was the MAC address of the network device 14 is replaced with the MAC address of the interface 16 and the message is sent over the interface 16. For incoming data received at the interface 16, the system 10 decrypts the payload, the destination address (which is the MAC address of interface 16 on the received packet) is replaced with the MAC address of the device 14 and the frame is sent over the interface 18. The device 14's MAC address may be pre-configured or learned at runtime through data flow across the system 10.

In the example where multiple network devices 14 are coupled to the network interface 18, the exemplary MAC security system 10 may learn the network devices' 14 MAC addresses via the Address Resolution Protocol (ARP) sent to its interface 18. The system 10 may store those associated MAC/IP addresses in its own table in the storage 28.

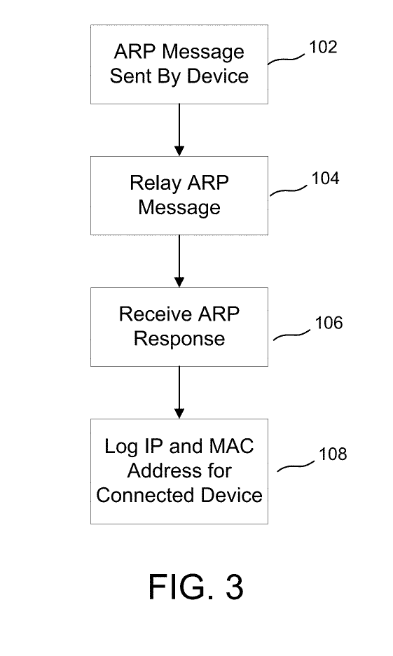

An example of the address resolution process and the building of a MAC translation table will be discussed with reference to FIG. 3. At step 102, a device such as the device 12 broadcasts an address resolution message seeking to connect with another device. The address resolution message includes the MAC address of the target device and the response sought includes the IP address of that device so that communications can thereafter commence. At step 104, the system 12 relays the ARP message to the devices 14 via the interface 18. At step 106, the system 10 receives a response from one or more of the devices 14 including the IP address for the connected device 14. At step 108, the system 10 logs the IP and MAC address for the connected device 14 in its table in the storage 28. The logging may first search the table to confirm that the IP/MAC address is not already listed in the table before adding the IP/MAC association to the table.

When the system 10 receives an encrypted IEEE 802.3 packet via its encrypted network interface 12, it decrypts the incoming messages. Based on the IP header's destination address, it finds the matching MAC address of the connected network device 14. It builds the IEEE 802.3 Ethernet data packet with the destination MAC address as the identified MAC address of the network device 14. The source MAC address may remain unchanged and the IEEE 802.3 payload may be replaced with the decrypted contents.

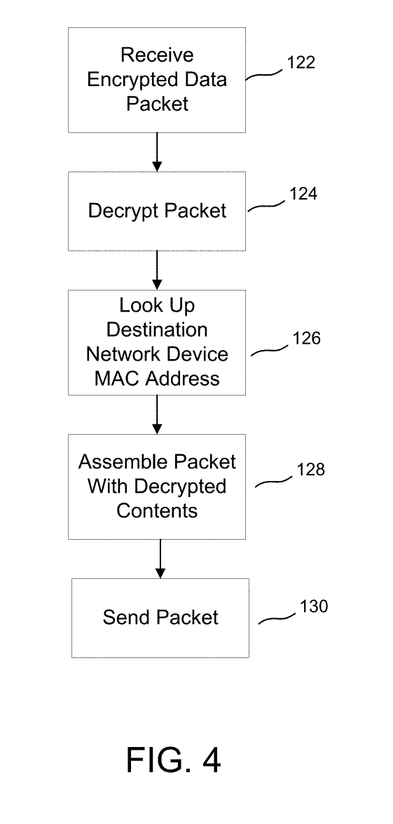

FIG. 4 illustrates a flow chart of processing a message received at the encrypted network interface 16. At step 122, the system 10 receives an encrypted data packet from the encrypted interface 16. The data packet may be an IEEE 802.03 data packet. At step 124, the payload of the packet is decrypted. As step 126, the system 10 looks up the MAC address of the destination device 14 from the IP/MAC address table. At step 128, the system 10 assembles a packet with the decrypted contents and the destination set to the corresponding device 14. At step 130, the assembled packet is sent over the network interface 18.

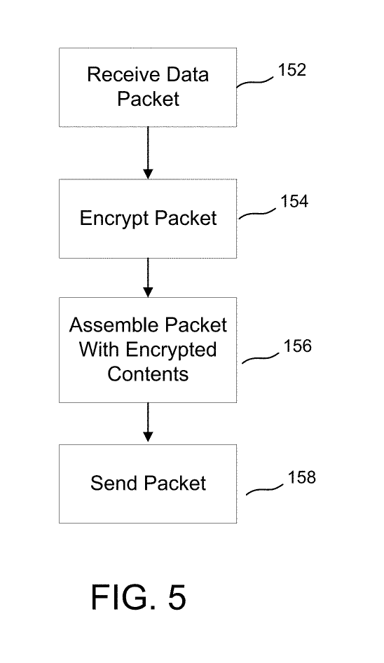

FIG. 5 illustrates a flow chart of processing a message received at the network interface 18. At step 152, the system 10 receives a data packet at the interface 18. At step 124, the payload of the packet, which may be clear text, is encrypted. At step 156, the system 10 assembles a packet with the encrypted contents. The source MAC address of the incoming packet may be replaced with the interface 16's MAC address in the assembled packet. At step 158, the assembled packet is sent over the network interface 16.

Referring back to FIG. 1, mobile devices 24 may communicate with the system 10 via the Bluetooth interface 20 and/or the WiFi interface 22 (e.g., 802.11 a/b/g/n 802.1ac. The mobile computing devices 24 may include, but are not limited to, smart phones, smart tablets and handheld computers. The mobile computing devices 24 may setup a trusted path with the system 10. The trusted path options include, but are not limited to, a TLS session, a DTLS session, a SSH session and a IPsec tunnel.

The mobile computing devices 24 may perform configuration and management activities for the exemplary Ethernet MAC security system 10. The configuration and management parameters may be sent over the trusted path.

In an example, the mobile device 24 and the encrypted network device 12 respectively are in communication with a provisioning service 30. The mobile device 24 is provided with a unique code associated with the system 10. For example, the system 10 may include a label with a QR code that can be scanned by the mobile device or the mobile device may communicate with the system 10 over short range radio (Bluetooth, NFC, etc). The mobile device may communicate the code with the provisioning service to determine a shared secret for the link between the encrypted network interface 16 and the encrypted network device 12. This shared secret is provided to the system 10 by the mobile device 20. The shared secret now known by both the encrypted network interface and the encrypted network device 12 provides an authentication credential to secure the link between the encrypted network interface 16 and the encrypted network device 12.

It will be appreciated that in some protocols such as IEEE 802.1ae every port on a switch may have a different shared secret. Thus, even if one port is monitored (sniffed), the other traffic is secured with different keys. The provisioning technique allows for the creation of a very secure link between the system 10 and the encrypted network device 12. Because the device 14 may be a legacy LAN device that does not have the capability to do the encryption based on the shared secret (e.g., IEEE 802.1ae), connecting the network device 14 to the network device 12 previously presented a security risk. With the inclusion of the system 10, the main link to the encrypted device 12 is secure. The system 10 may be small and low cost to be located in close physical proximity to the network device 14. Thus, the length of unsecured links can be significantly reduced—for example to mere inches or feet that can be physically secured. The disclosed approach provides the exemplary benefit of securing hardware—particularly hardware such as military, industrial, medical hardware that is not easily modified.

In the processes described with respect to FIGS. 4 and 5, packets are decrypted at step 124 and encrypted at step 154. In some embodiments, additional steps may be included to overcome incompatibilities between secure systems and legacy LAN systems. For example, in the case of IEEE 802.3 Ethernet packets that may be used on the link between the network interface 18 and the network device 14, a very large payload is available. The network device 14 may therefore send very large packets. The encrypted link between the encrypted network device 12 and the encrypted network interface 16 may use IEEE 802.1ae, which is more limited in packet size. The use of a translator to repack the data into more packets is undesirable as this would require changes at the network device 14 that it is not possible to make due to its legacy or certificated status. Such a translation technique would also involve logic at a higher level in the OSI model and whereas the system 10 preferably operates at OSI level 2 for more seamless integration of the network. The system 10 may constrain the network device 14 to limit the size of the packets sent by the network device 14 so that they can be encrypted and sent over the encrypted link to the encrypted network device 12.

Examples of constraining the size of the packets of the network device 14 will now be described. Of course, it will be appreciated that these techniques may be used alone or together and may be modified within the scope and spirit of the disclosure.

With reference to FIG. 2, a method of VLAN encryption performed by the exemplary Ethernet MAC security system 10 will be described. The system 10 may use a static AES encryption key with its peer 12. The AES encryption keys can be configured by the mobile computing device 24 with key length of 128, 192 and 256 bits. The system 10 may use AES CCM mode. The first 6 bytes of the data frame provide the destination MAC address and source MAC address may remain in clear text. The next 8 bytes provide a vendor specific header. The CCM header may include a packet number that is a 4 byte field that may increment from 0 to 232-1 and a 4 byte system jiffies field that may be a value associated with the system time stamp. The payload may be encrypted content with AES CCM. Its size may vary from 16-1480 bytes. The last 8 bytes is the Message Integrity Checksum (MIC), which may be a result of AES CCM encryption. In this example of the VLAN encryption, with an Ethernet MTU of 1500 and the 3 header, the data and length field (2 bytes) in the crypto header describe the data length as 14-1478 bytes. Considering the 2 bytes taken by the length field, the length may be 16-1480 and 16 bytes are available for the size of an AES encryption block.

The exemplary Ethernet MAC security system 10 may address the issues of discrepant Maximum Transmission Unit (MTU) size between its encrypted interface 16 and its network interface 18. The network devices 14 connected with interface 18 may have a default MTU size of 1500 bytes as defined by IEEE 802.3 standard. The encrypted Ethernet interface 16 may have a MTU size less than 1500 bytes due to the addition of encryption headers.

The system 10 may send an Internet Control Message Protocol (ICMP) “Fragmentation Needed” (Type 3, Code 4) message to indicate its MTU to network devices 14, and the network device 18 may reduce its Path MTU appropriately. In response to a Fragmentation Needed message, the network device 14 will send less payload per Ethernet packer. The system 10 may repeat sending the Fragmentation Needed messages until the MTU is adjusted for all connected network devices 14 and the payload is sufficiently small such that after encryption the received packet may be sent in one packet on the encrypted link.

In the case of IPv6, the system 10 may send back an ICMPv6 Packet Too Big (Type 2) message including its MTU over the network interface 18, and the network device 14 may reduce its Path MTU appropriately. The process may be repeated until the MTU is adjusted for all connected network devices 14.

Another approach is to utilize the Ethernet jumbo frame size (up to 9000 bytes) by the Ethernet switch that interface 16 is connected to. The system 10 can discover this feature by using Link Layer Discovery Protocol (LLDP). Annex G of the LLDP specification defines this Type-Length-Value (TLV): Maximum Frame Size TLV (OUI=00-12-0f, Subtype=4).

It will be appreciated that the above described exemplary processes and systems provide an improvement to networking technology. A system may provide data bridging and translation services between an encrypted interface and an unencrypted interfaces. The encrypted interface may perform IEEE 802.1ae encryption as a host and/or perform VLAN based static key encryption. The system may adjust the MTU size of devices connected to the unencrypted ports and perform data bridging services.

An integrated security system may include an encrypted Ethernet port and one or more clear text ports, an interface of the system being configured to bridge and translate encrypted data to and from the clear text ports. The interface may be configured to perform data encryption using at least one of an IEEE 802.1ae Ethernet host and static keys. The processor may be configured to bridge and translate the encrypted data. The clear text ports may include one or more Ethernet ports and wireless communication interfaces such as Bluetooth and WiFi (IEEE802.11). The clear text interfaces may include one or more Bluetooth interfaces. The clear text interfaces may include one or more 802.11a/b/g/n or 802.11ac interfaces.

A method may include providing data encryption for IEEE 802.3 virtual LAN (VLAN) using static keys on an encrypted interface. A method may include controlling a peer's maximum transmission unit (MTU) size of an Ethernet data frame, the peer being connected to a clear text port of the system. A method may include installing a key into the system via Bluetooth or NFC interfaces of an external devices such as a computer, a smart phone or a mobile computing device.

An exemplary benefit of the system is to provide a secure network link to LAN hardware that otherwise does not support more advanced security protocols. This is particularly advantageous for hardware such as military, industrial, and medical hardware that is not easily modified or subject to certification processes that limit the ability to change the devices.

Although the invention(s) is/are described herein with reference to specific embodiments, various modifications and changes can be made without departing from the scope of the disclosure. For example, while network interfaces may be illustrated directly to network devices, it will be appreciated that various switches, hubs and other network equipment may be disposed between the interfaces and devices. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

1. A network security apparatus, comprising:
a memory configured to store an address lookup table;
a first network interface;
a second network interface; and
a processor operatively coupled to the memory, the first network interface, and the second interface, the processor being configured to:
receive a first address resolution message at the first network interface,
transmit a second address resolution message at the second network interface,
populate the address lookup table based on a response to the second address resolution message received at the second network interface, and
bridge encrypted network traffic at the first network interface to a different network encryption at the second network interface.

2. The network security apparatus of claim 1, wherein the processor is configured to receive an encrypted message at the first network interface, decrypt the encrypted message, and transmit a message based on the decrypted message at the second network interface.

3. The network security apparatus of claim 2, wherein the processor is configured to set a destination address of the encrypted message to a medium access control (MAC) address stored in the address lookup table.

4. The network security apparatus of claim 1, wherein the processor is configured to receive a message at the second network interface, encrypt the message, and transmit the encrypted message at the first network interface.

5. The network security apparatus of claim 4, wherein the processor is configured to set a source address of the encrypted message to a MAC address associated with the first network interface.

6. The network security apparatus of claim 1, wherein the first network interface includes an IEEE 802.1ae interface, and the second network interface includes an IEEE 802.3 interface or VLAN encryption.

7. The network security apparatus of claim 1, wherein the address resolution message includes an Address Resolution Protocol (ARP) message.

8. The network security apparatus of claim 1, wherein the processor is configured to transmit a message at the second network interface to reduce a payload size of messages received at the second network interface.

9. The network security apparatus of claim 8, wherein the message to reduce the payload size includes at least one of an Internet Control Message Protocol Fragmentation Needed message, and an ICMPv6 Packet Too Big message.

10. The network security apparatus of claim 1, wherein the processor is configured to utilize a Link Layer Discovery Protocol message at the first network interface to enable an Ethernet jumbo frame size.

11. The network security apparatus of claim 1, wherein the first network interface includes encryption, and the second network interface includes clear text.

12. A network security apparatus, comprising:
a memory configured to store an address lookup table;
a first network interface;
a second network interface; and
a processor operatively coupled to the memory, the first network interface, and the second interface, the processor being configured to:
bridge encrypted network traffic at the first network interface to a different network encryption at the second network interface, and
control a transmit size of messages received at the second network interface.

13. The network security apparatus of claim 12, wherein the processor is configured to transmit a message at the second network interface to reduce a payload size of messages received at the second network interface.

14. The network security apparatus of claim 13, wherein the message to reduce the payload size includes at least one of an Internet Control Message Protocol Fragmentation Needed message, and an ICMPv6 Packet Too Big message.

15. The network security apparatus of claim 12, wherein the processor is configured to utilize a Link Layer Discovery Protocol message at the first network interface to enable an Ethernet jumbo frame size.

16. The network security apparatus of claim 12, wherein the first network interface includes encryption, and the second network interface includes clear text.

17. The network security apparatus of claim 12, wherein the processor is configured to receive an encrypted message at the first network interface, decrypt the encrypted message, and transmit a message based on the decrypted message at the second network interface.

18. The network security apparatus of claim 17, wherein the processor is configured to
populate an address lookup table based upon network traffic between the first network interface and the second network interface, and
set a destination address of the encrypted message to a (medium access control) MAC address stored in the lookup table.

19. The network security apparatus of claim 12, wherein the processor is configured to receive a message at the second network interface, encrypt the message, and transmit the encrypted message at the first network interface.

20. The network security apparatus of claim 19, wherein the processor is configured to set a source address of the encrypted message to a MAC address associated with the first network interface.

21. The network security apparatus of claim 12, wherein the first network interface includes an IEEE 802.1ae interface, and the second network interface includes an IEEE 802.3 interface.
